(19) United States
(12) Patent Application Publication
(10) Pub. No.: US 2018/0205611 A1
(43) Pub. Date: Jul. 19, 2018

(54) NETWORK ENUMERATION AT A NETWORK VISIBILITY NODE

(71) Applicant: Gigamon Inc., Santa Clara, CA (US)

(72) Inventors: Simon H Gibson, Santa Clara, CA (US); Shehzad Merchant, Santa Clara, CA (US)

(21) Appl. No.: 15/406,500

(22) Filed: Jan. 13, 2017

(51) Int. Cl. H04L 12/24; H04L 12/26; H04L 29/08

(52) U.S. Cl. CPC H04L 41/12; H04L 67/26; H04L 43/04

(57) ABSTRACT

Techniques are disclosed for identifying entities (e.g. users, devices, applications, etc.) connected to a computer network. Operations in accordance with the disclosed techniques can be performed at one or more network visibility nodes that operate as part of a visibility fabric, for example for monitoring traffic on the network. In certain embodiments, packets associated with the traffic are received at a network visibility node communicatively coupled to the network that is operable to enable visibility across the network. The network visibility node processes the packets to identify entities connected to the network and generates network enumeration data based on the processing. In some embodiments, the network enumeration data is accessible via a service to subscribers of the service.

### TECHNICAL FIELD

The present disclosure generally relates to analysis of network traffic, and more particularly to network enumeration at a network visibility node.

### BACKGROUND

Increasingly complex computer networks can facilitate communication among numerous entities such as devices, applications, and users. This presents challenges from a network management and network security standpoint. As the complexity of a computer network grows, it becomes increasingly more difficult to gather a clear picture of the entities accessing a computer network at any given moment. With ever-increasing amounts of data traffic on modern computer networks, network monitoring and security measures play an increasingly important role in reducing the vulnerability of a computer network to intrusion, unauthorized access, and other security or performance issues. Tools can be deployed in a computer network that process the network traffic and provide monitoring and security services. Examples of network tools include an intrusion detection system (IDS), an intrusion prevention system (IPS), a sniffer, a network monitoring system, an application monitoring system, a forensic storage system, and an application security system, among others. However, the effectiveness of such network tools is limited by the network traffic that the tools can see. Existing approaches involve deploying multiple editions of the same tool across a computer network to increase visibility of the network traffic. This approach can be expensive and difficult to scale and manage.

### BRIEF DESCRIPTION OF THE DRAWINGS

The present disclosure is illustrated by way of example, and not by way of limitation, in the figures of the accompanying drawings and in which like reference numerals refer to similar elements. The figures of the accompanying drawings depict only example embodiments of the present disclosure and are therefore not to be construed as limiting. in the drawings:

FIG. 1A shows an architecture diagram of an example networked computing environment:

FIG. 1B shows and architecture diagram illustrating the implementation of a visibility fabric with the example networked computing environment of FIG. 1A;

FIG. 2A shows an example network visibility node;

FIG. 2B shows an example in-line configuration of the example network visibility node of FIG. 2A;

FIG. 3 shows a box diagram illustrating an example network enumeration module;

FIG. 4A shows a first flow diagram illustrating a first example processes for network enumeration;

FIG. 4B shows a second flow diagram illustrating a second example process for network enumeration;

FIG. 4C shows a third flow diagram illustrating a third example process for network enumeration;

FIG. 4D shows a fourth flow diagram illustrating a fourth example process for network enumeration;

FIG. 5 shows the deployment of the network visibility node of FIGS. 2A-2B in a network environment; and

FIG. 6 is a block diagram illustrating an example computer processing system in which at least some operations described herein can be implemented.

### DETAILED DESCRIPTION

### Overview

Introduced herein are techniques that address certain network management and security challenges resulting from the increasing complexity of modern computer networks. Specifically, techniques are described for performing network enumeration through the use of a visibility fabric that enables visibility into the network traffic on a given computer network. As used herein, the term “network enumeration” generally refers to the gathering of information regarding entities (e.g. devices, users, applications, etc.) associated with a computer network. This process can include identifying such entities, determining roles and capabilities of such entities, and/or determining relationships between identified entities. Note that the term “network enumeration,” as used herein, may refer to and/or encompass other commonly used terms such as “network mapping,” “network discovery,” “network monitoring,” “network characterization,” “network inventory,” etc.

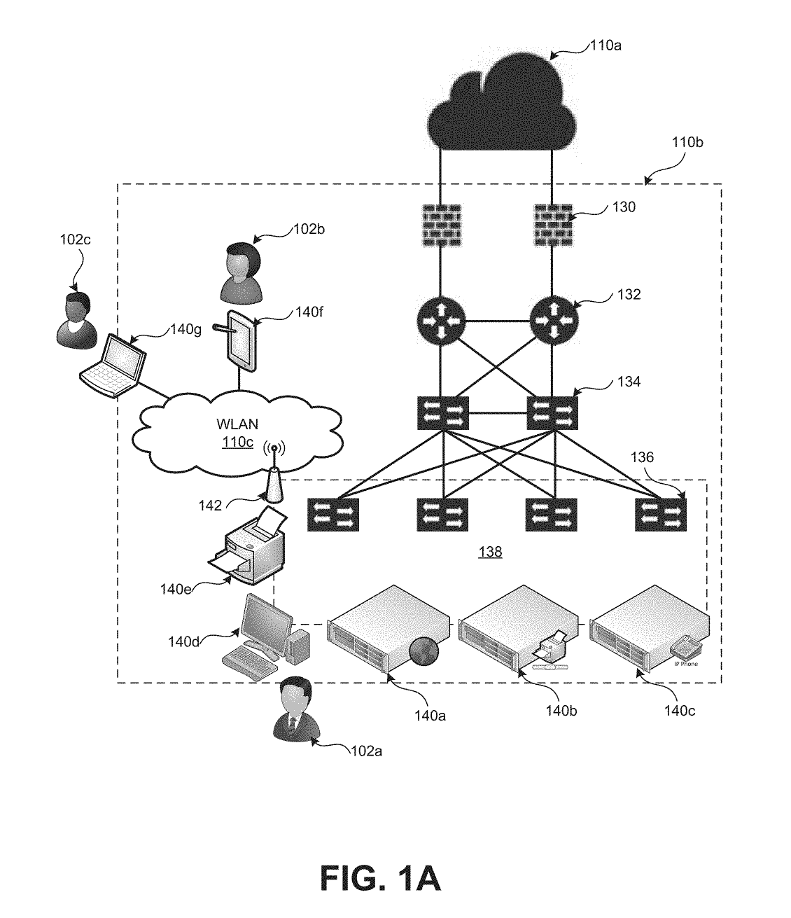

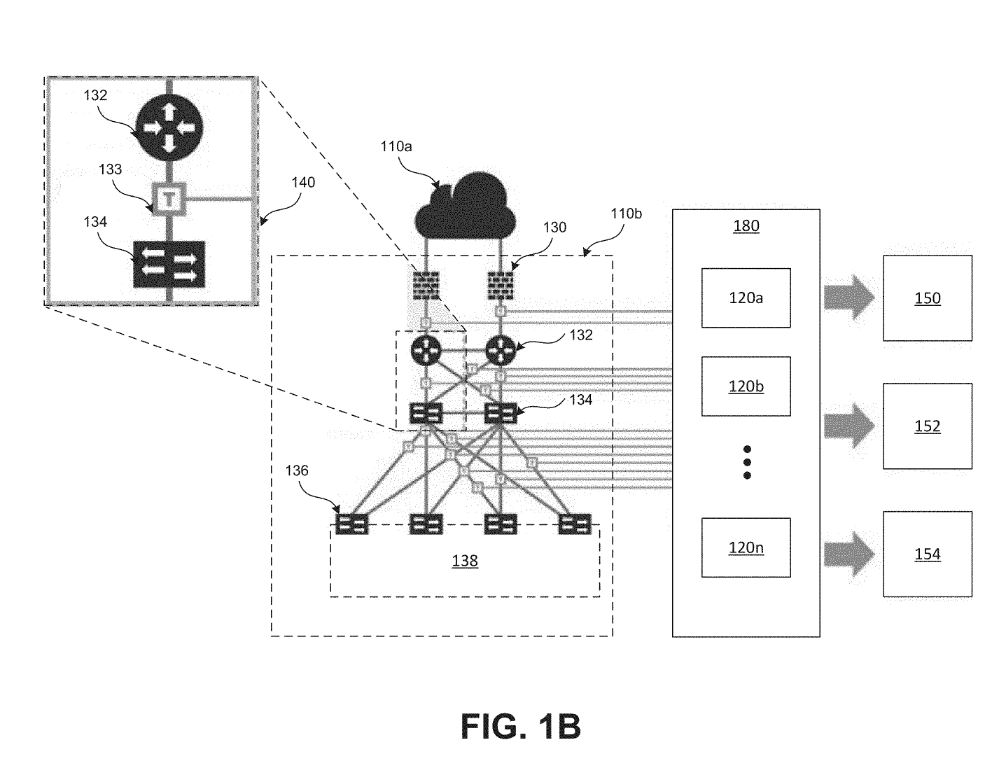

A networked computing environment can include multiple devices connected over a computer network. FIG. 1A shows an architecture diagram of an example networked computing environment, according to some embodiments. For example, as shown in FIG. 1A, the example environment includes a computer network 110b (as shown enclosed within the dotted line box labeled 110b). The example computer network 110b may be a local (possibly private) packet-switched network, for example associated with a particular organization. As shown in FIG. 1A, network 110b can include one or more firewall devices 130, router devices 132, “spine” switch devices 134, and/or “leaf” switch devices 136 configured to facilitate communication between computing devices 140a-g and with other networks such as a public network 110a (e.g. the Internet). At an access layer 138 computing devices 140a-g connect to network 110b, for example via leaf switches 136 and/or via wireless network 110c supported by a wireless access point 142. Computing devices can include servers (e.g. webs servers 140a, print servers 140b, voice over IP (VOIP) servers 140c, etc.), user devices (e.g. desktop computers 140d, printers, 140e, laptop computers 140g, mobile devices 140f, etc.). Users 120a-c may access networks 110a and 110b via any of the devices 140a-f. Further, although not shown, devices (e.g. 130, 132, 134, 136, and 140a-g) may execute one or more applications that generate traffic over the networks 110a-b. The devices (e.g. 130, 132, 134, 136, and 140a-g), users (e.g. users 102a-c), and applications (not shown) are collectively referred to herein as “entities” or “network entities” associated with the computer network (e.g. 110a-b).

Although FIG. 1A presents one possible representation of several entities that may reside on an example computer network, a real-world implementation will likely include hundreds or even thousands of different entities, possibly in multiple physical locations. As previously mentioned, this presents a challenge from a network management and network security standpoint. As the complexity of a computer network grows, it becomes increasingly more difficult for a network administrator or information security officer to gather a clear picture of the entities accessing a managed network at any given moment. In some cases, network tools can be deployed to process network traffic and provide monitoring and security services. Devices forming the core of a production network may, in some cases, include such tools to manage connected devices in a computer network. For example, a router 130 may maintain a database of managed devices (e.g. a Management Information Database (MIB)) through the use of a management protocol (e.g. the Simple Network Management Protocol (SNMP)). In some cases, devices connecting to a network may be configured to announce their identity and capabilities (e.g. through the use of SNMP). However, existing solutions are only as effective as the network traffic that they can see and/or the ability by the administrator to configure connected devices for centralized management (e.g. using SNMP agents). For example, existing approaches to network monitoring typically involve deploying multiple editions of the same network tool across a computer network to increase visibility of the network traffic. Such approaches can be expensive and difficult to scale and manage.

To address these challenges, the process of network enumeration can be performed at a device or set of devices that enable visibility across the network 110b. For Example, as shown in FIG. 1B, in some embodiments a network visibility fabric 180 may be implemented to enable visibility across a given network (e.g. network 110b). In other words, a visibility fabric 180 can be implemented to enable access to network traffic passing over a given network. This network traffic can then be processed (as described in more detail herein) to gather information regarding entities associated with the computer network. For example, with regard to FIG. 1A, accessed network traffic (e.g. packets) can be processed to identify devices, applications, users etc. associated with a network (e.g. network 110b). This process of identifying entities can in turn also include determining roles, capabilities, relationships, etc. associated with the identified entities. For example, by processing network traffic, a system in accordance with the present disclosure may identify user 102c as associated with device 140g as well as various applications (not shown) instantiated at device 140g. Such a system may further determine that user 102c is communicating with user 102a at device 140d using one or more other applications (not shown). Similarly, by processing network traffic, a system in accordance with the present disclosure may determine a role associated with a particular server device connected to the network. For example, the system may determine that a server is any of a web server 140a, a print server 140b, or a VOIP server 140c. These are just some examples, provided for illustrative purposes, of information that may be gathered through a process of network enumeration and are not to be construed as limiting.

Returning to FIG. 1B, in some embodiments this visibility fabric can include the network infrastructure (both physical and logical) that sits between a production network such as network 110b and one or more tools 150, 152, 154 that provide services related to network performance monitoring, application performance monitoring, security, management, etc. The visibility fabric 180 itself may include one or more physical and/or virtual devices 120a-n that tap into a given network 110b to receive traffic to extract metadata and/or forward to tools 150, 152, 154 for processing. For example, the visibility fabric 180 depicted in FIG. 1B shows multiple taps across network 110b from which network traffic may be routed. A detail showing an example tap 133 between devices on a network is shown in detail 140. In some embodiments a visibility fabric 180 and associated tools 150, 152, 154 may be in-line with the network 110b. In such configuration, packets originating from a source node on a network are routed through the visibility fabric 180 and associated one or more tools 150, 152, 154 before continuing on to a destination node. In other embodiments the visibility fabric 180 and one or more tools 150, 152, and 154 may be implemented to be out-of-band with the network. In this configuration, instead of routing packets through the visibility fabric 180 before continuing to a destination node, copies of packets transmitted over a network are pulled off the network (e.g. at the one more tap locations 133) for monitoring without impacting the end-to-end communication between nodes. In some embodiments, the visibility fabric 180 may have both in-line and out-of-band functionality. An example of a visibility fabric that may be suitable for use as visibility fabric 180 may include one or more of the GigaVUE series of products from Gigamon, Inc. of Santa Clara, Calif.

As mentioned, a visibility fabric 180 including one more devices 120a-n can provide traffic visibility across a network to enable services related to, for example, network performance monitoring, application performance monitoring, security, management, etc., using, for example, tools 150, 152, 154. The infrastructure implemented as part of a visibility fabric 180 can similarly be utilized to perform enumeration of entities associated with the network 110b. In some embodiments, this process can be performed by the one or more devices (physical or virtual) 120a-n forming the visibility fabric and/or by the one or more tools (physical or virtual) 150, 152, 154 that are communicatively coupled to the network via the visibility fabric 180. Performing network enumeration at one or more devices operating as part of a visibility fabric 180 has a number of benefits. The visibility fabric 180 enables network traffic visibility across a given network which addresses the challenges of limited visibility inherent in performing these processes, for example, at one or more of the switches or routers operating within the production network. The visibility fabric 180 enables centralization of enumeration process which helps with manageability and scalability. Offloading of certain enumeration activities from devices operating in the production network through the use of a visibility fabric 180 also helps to alleviate strain on the limited processing resources of these production network devices. In out-of-band implementations, offloading of network enumeration activities from devices operating in the production network using the visibility fabric 180 can also help to alleviate network traffic congestion caused by the processing required to perform these activities. Further, although active scanning and management messaging may be employed in some embodiments, in other embodiments the processes performed in the visibility fabric 180 may be passive in nature (relying on the analysis of received network traffic) which avoids the congestion that may be caused by the introduction of additional traffic (e.g. SNMP messaging) onto the production network,

### Example Network Visibility Node

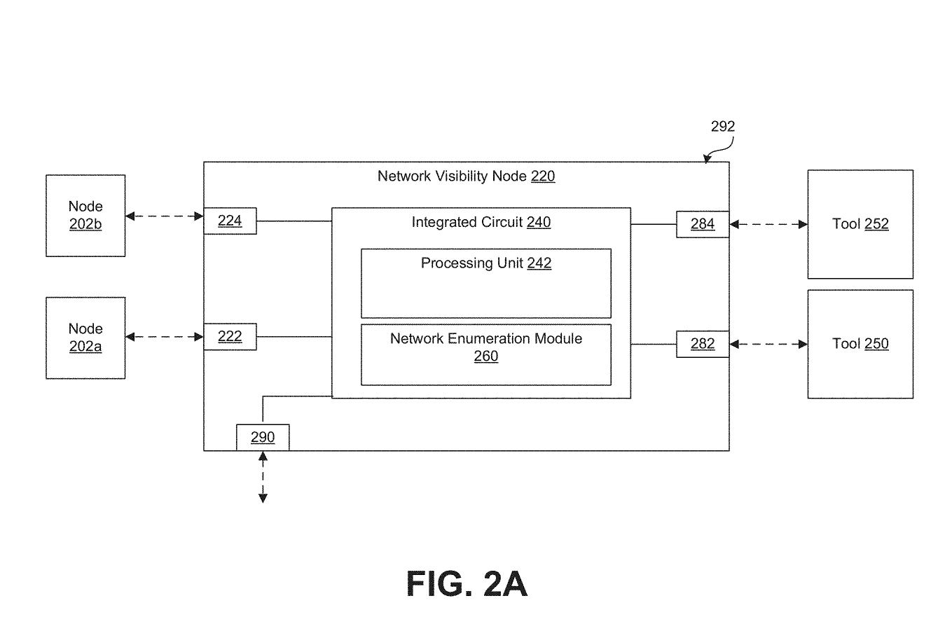

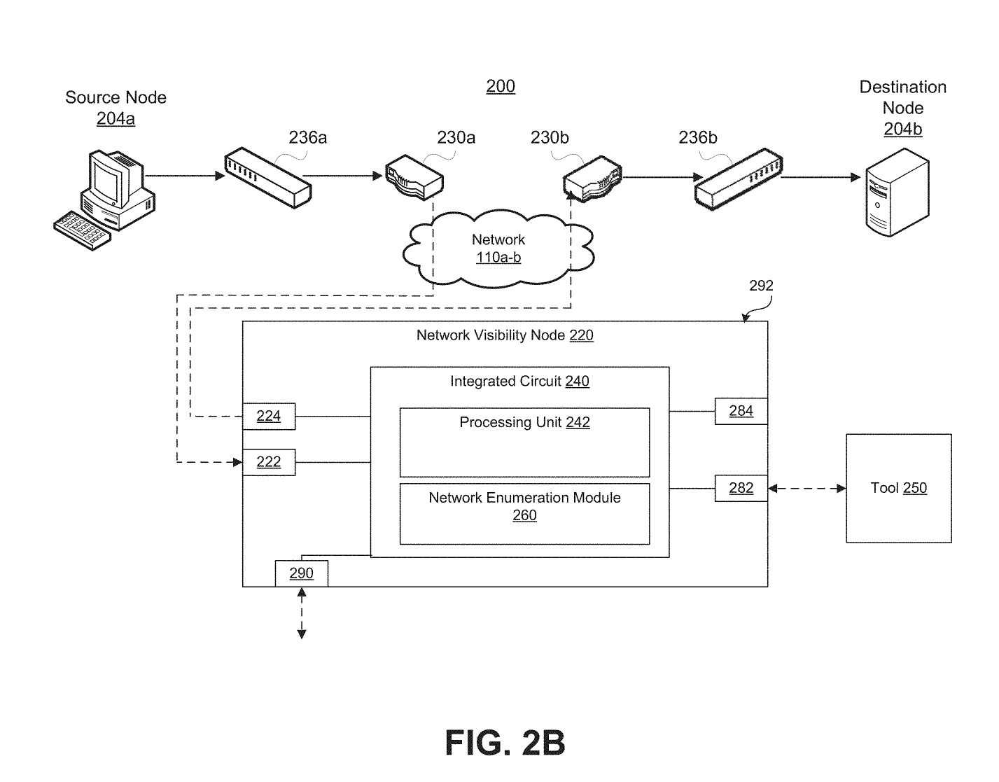

FIG. 2A illustrates an example network visibility node 220 in accordance with some embodiments. In some embodiments, the one or more devices 120a-n operating as part of the visibility fabric 180 described with respect to FIG. 1B may include a network visibility node 220 such as depicted in FIG. 2A. It will be appreciated that the network visibility node 220 and associated systems are only examples provided for illustrative purposes. The example network visibility node 220 includes a housing 292, one or more network ports 222, 224, and one or more instrument ports 282, 284. The network visibility node 220 also includes one or more integrated circuits 240 which in some embodiments may include one or more processing units 242. Note the network visibility node 220 with a housing 292 is depicted in FIG. 2A as physical device. However, in other embodiments a network visibility node with similar functionality to network visibility node 220 may be implemented at least partially in software (i.e. virtualized) within a physical device or distributed across multiple physical devices.

The network visibility node 220 also includes a network enumeration module 260 which along with processing unit(s) 242 may perform one or more of the operations described herein. The network enumeration module 260 is depicted separate from the processing unit 242, but may in some embodiments be integrated. Further processing unit 242 and network enumeration module 260 are depicted as part of integrated circuit 240, but may in some embodiments comprise separate modules. In the illustrated embodiments, the network visibility node 220 also includes other components, such as a Network PHY (not shown) coupled to each of the respective ports 222, 224 and 282, 284, wherein the Network PHYs may be considered to be parts of the integrated circuit 240. Alternatively, the Network PHYs may be considered to be components that are separate from the integrated circuit 240. The PHY is configured to connect a link layer device to a physical medium such as an optical fiber, copper cable, etc. In other embodiments, instead of the PHY, the network visibility node 220 may include an optical transceiver, or a SERDES, etc. The housing 292 allows the network visibility node 220 to be carried, transported, sold, and/or operated as a single unit. The ports 222, 224 and 282, 284 are located at a periphery of the housing 292. In other embodiments, the ports 222, 224 and 282, 284 may be located at other locations relative to the housing 292. Although two network ports 222 and 224 are shown, in other embodiments, the network visibility node 220 may include fewer or more than two network ports. Also, although two instrument ports 282 and 284 are shown, in other embodiments, the network visibility node 220 may include fewer or more than two instrument ports. In addition, in some cases, the network visibility node 220 may not include any instrument ports for communication with network tools. Furthermore, in some cases, the instrument ports 282, 284 may be configured to communicate with one or more tools 250, 252, for example for network monitoring. Tools 250, 252 may be the same or similar to tools 150, 152, 154 described with respect to FIG. 1B. The one or more tools 250, 252 may include one or more network tools. In other cases, the one or more tools 250, 252 may be one or more non-transitory media, such as one or more storage devices, one or more databases, etc. In some embodiments the one or more tools 250, 252 may represent physical and/or virtual devices.

In an embodiment, during use, a first network port 222 of the network visibility node 220 is communicatively coupled (e.g., via a network 110a-b) to a first node 202a, and a second network port 224 is communicatively coupled (e.g., via the network 110a-b) to a second node 202b. The term “node” in this context may refer to an entity (e.g. device or application) communicating over the network. Communication may be over a combination of private and public networks (e.g. the Internet), for example, the combination of networks 110a and 110b depicted in FIGS. 1A-1B. In some embodiments, the network visibility node 220 is configured to receive packets from nodes 202a-b via the network ports 222, 224. Packets received from nodes 202a-b can be processed according to the techniques described herein at the processing unit 242 of network visibility node 220 and/or forwarded on to one or more external tools 250, 252 via instrument ports 282, 284 for processing. In in-line configurations, the received packets are then forwarded on to the destination node (e.g. node 202a or 202b) after processing (at network visibility node 220 and/or the one or more external tools 250, 252.

As previously described, in some embodiments, instrument ports 282, 284 of the network visibility node 220 are communicatively coupled to respective tools 250, 252. The tools 250, 252 may be directly coupled to the network visibility node 220 or communicatively coupled to the network visibility node 220 through a network (e.g., network 110a-b). In some cases, the network visibility node 220 is provided as a single unit that allows the network visibility node 220 to be deployed at a single point along a communication path. In the illustrated embodiments, the network visibility node 220 (e.g., the integrated circuit 240) is configured to receive packets from nodes 202a-b via the network ports 222, 224 and process the packets in accordance with a predefined scheme. In some embodiments, the integrated circuit 240 in the network visibility node 220 may analyze packets received from nodes 220a-b to determine information regarding the network traffic and pass (e.g. forward) that network traffic information downstream for processing. This network traffic information can include the packets themselves and/or extracted metadata based on the analysis. For example, in an embodiment the integrated circuit 240 in the network visibility node 220 may analyze received packets to determine network traffic information (e.g., identity, roles, capabilities, etc.) regarding entities along a communication path over the network and pass the determined information downstream (e.g. to a network enumeration module 260) for processing. In some embodiments, the integrated circuit 240 may pass the determined network traffic information for storage in a non-transitory medium. Alternatively, or additionally, the integrated circuit 240 may pass the determined network traffic information along with the associated packets received from one or more nodes to one or more tools 250, 252 that are connected to respective instrument port(s) 282, 284. Note that tools 250, 252 may not be necessary to the process of network enumeration where that process is performed at the network visibility node 220.

In some embodiments, one or more of the network ports 222, 224 may be configured to receive normal packets (e.g., packets not from a virtualized network), as well as virtualized packets (e.g., packets with tunnel format that includes an encapsulation of the original packets resulting from virtualization technology). In other embodiments, one or more the network ports 222, 224 may be configured to receive only non-virtualized packets. In further embodiments, one or more the network ports 222, 224 may be configured to receive only virtualized packets.

In one or more embodiments, the integrated circuit 240 may be or include any switch module that provides packet transmission in accordance with a pre-determined transmission scheme. In some embodiments, the integrated circuit 240 may be user-configurable such that packets may be transmitted in a one-to-one configuration (i.e., from one network port to an instrument port). As used in this specification, the term “instrument port” refers to any port that is configured to transmit packets to a tool (e.g. tool 250, 252), wherein the tool may be a non-pass through device (i.e., it can only receive packets intended to be communicated between two nodes, and cannot transmit such packets downstream), such as a snifter, a network monitoring system, an application monitoring system, an intrusion detection system, a forensic storage system, an application security system, a database, etc., or the instrument may be a pass-through device (i.e., it can receive packets, and transmit the packets back to the network visibility node 220 after the packets have been processed), such as an intrusion prevention system. In other embodiments, the integrated circuit 240 may be configured such that the packets may be transmitted in a one-to-many configuration (i.e., from one network port to multiple instrument ports). In other embodiments, the integrated circuit 240 may be configured such that the packets may be transmitted in a many-to-many configuration (i.e., from multiple network ports to multiple instrument ports). In further embodiments, the integrated circuit 240 may be configured such that the packets may be transmitted in a many-to-one configuration (i.e., from multiple network ports to one instrument port). In some embodiments, the one-to-one, one-to-many, many-to-many, and many-to-one configurations are all available for allowing a user to selectively configure the network visibility node 220 so that the packets (or certain types of packets) are routed according to any one of these configurations. In some embodiments, the packet movement configuration is predetermined such that when the network visibility node 220 receives the packets, the network visibility node 220 will automatically forward the packets to the ports based on the predetermined packet movement configuration (e.g., one-to-one, one-to-many, many-to-many, and many-to-one) without the need to analyze the packets (e.g., without the need to examine the header, determine the type of packets, etc.).

In accordance with some embodiments, the integrated circuit 240 may have the functionalities of a conventional packet switch except that it provides visibility into various parts of a network. Thus, embodiments of the integrated circuit 240 may operate like a conventional managed packet switch, but provide packet monitoring functionality. This is accomplished by configuring the integrated circuit 240 to operate as a circuit switch under certain circumstances. In some embodiments, the configuring of the managed packet switch may be performed by utilizing a CPU interface of the switch to modify appropriate registers in the switch to allow for the desired operation. Also, in some embodiments, the integrated circuit 240 may be an “out-of-band” network switch, which is configured to obtain packets and pass them to a tool or to a network that is different from that associated with the original intended destination of the packets.

Also, the term “out-of-band” device/switch refers to a device that is not involved in a transmission of a packet (that is transmitted from node 1 and intended for reception by node 2) to the intended receiving node 2. In some cases, a device may be both an in-band device and an out-of-band device with respect to processing different packets. For example, the network visibility node 220 may be an in-band device if it receives a packet (intended for transmission from node 1 to node 2) from a network, and passes the packet back to the network (e.g., after the packet has been processed by a pass-through network tool) for transmission downstream to the node 2. The same network visibility node 220 may also be an out-of-band device if it receives another packet from the network, and does not pass the packet back to the network for transmission to the intended receiving node.

It should be noted that the integrated circuit 240 that may be used with the network visibility node 220 is not limited to the examples described above, and that other integrated circuits 240 with different configurations may be used as well. Also, in one or more embodiments described herein, the integrated circuit 240 may be implemented using a processor (e.g., a general purpose processor, a network processor, an ASIC processor, a FPGA processor, etc.

In other embodiments, the network visibility node 220 may optionally include an additional processing unit (e.g., a processor) communicatively coupled to the processing unit 142. The additional processing unit may be used to perform additional packet processing, such as header stripping, in some embodiments. For example, in some embodiments, the additional processing unit may be configured to receive only packets with a tunnel format, such as that used in a virtualized network, In one implementation, the processing unit 242 or the integrated circuit 240 is configured to pass all packets with a tunnel format to the additional processing unit, and does not pass packets without any tunnel format (e.g., packets that are not associated with a virtualized network) to the additional processing unit. Upon receiving a packet with a tunnel format, the additional processing unit then removes one or more headers from the packet. By means of non-limiting examples, the additional processing unit may be configured to remove an outer MAC header, an outer IP header, an outer UDP header, or any combination of the foregoing, from the packet. In some embodiments, after the additional processing unit performs header stripping on the packet, the additional processing unit then passes the packet back to the integrated circuit 240. The integrated circuit 240 then transmits the packet to one or more of the instrument ports 282, 284 according to a pre-determined transmission scheme (e.g., one-to-one, one-to-many, many-to-one, many-to-many, etc.) as discussed previously. In other embodiments, in addition to performing packet stripping, the additional processing unit may also be configured to perform other packet processing functions on the received packet (e.g. a network enumeration process in conjunction with network enumeration module 260). In some embodiments, the additional processing unit may be located outside the housing of the network visibility node 220. In other embodiments, the additional processing unit may be a part of the integrated circuit 240. For example, the additional processing unit may be considered to be a part of the processing unit 242. Also, in some embodiments, the additional processing unit may be a general purpose processor, a network processor, an ASIC processor, a FPGA processor, or any of other types of processor. In other embodiments, the additional processing unit may be any hardware, software, or combination thereof.

In the illustrated embodiments, the processing unit 242 is illustrated as a component of the integrated circuit 240. In some cases, the processing unit 242 may be one or more processors in the integrated circuit 240. In other cases, the processing unit 242 may be one or more circuit components that are parts of the integrated circuit 240. In other embodiments, the processing unit 242 may be a separate component from the integrated circuit 240. The processing unit 242 may be implemented using a processor, such as a general processor, a network processor, an ASIC processor, a FPGA processor, etc. In other embodiments, the processing unit 242 may be a field processor. In further embodiments, the processing unit 242 may be a network card. The processing unit 242. may be implemented using one or more processors, wherein one or more of the processors may be considered to be a part of the network visibility node 220 or not. Also, in some embodiments, the integrated circuit 240 may include ternary content-addressable memory (TCAM). The integrated circuit 240 may be configured to perform various packet processing functions, included but not limited to packet filtering, packet routing, packet switching, packet mirroring, packet aggregation, etc.

As shown in the figure, the network visibility node 220 further includes one or more I/O port(s) 290 for importing and exporting data. For example, in an embodiment port 290 may include a configuration port for receiving configuration information to thereby configure any of integrated circuit 240, processing unit 242, or network enumeration module 260. For example, in an embodiment, data is received at port 290 for configuring a switching fabric associated with integrated circuit 240 and/or processing unit 242 according to a user-configured transmission scheme.

In some embodiments, I/O port(s) 290 may be a separate and different port from the other network ports 222, 224 and instrument ports 282, 284. In other embodiments, the port 290 may be a network port, like the network ports 222, 224 or may be implemented using one or both of the network ports. In such cases, in addition to receiving configuration information and exporting generated outputs, the port 290 may also receive network traffic that is being communicated between nodes (e.g., nodes 202a-b). Also, in further embodiments, the network visibility node 220 may include multiple I/O ports 290 for transmitting and receiving information.

In an embodiment, during use, the network visibility node 220 is configured to enable visibility into the traffic transmitted across a network (e.g. network 110b). Visibility can be enabled by “tapping” network traffic to and from nodes communicating over the network. In other words, the network visibility node 220 can be configured to tap packets being transmitted from a source node to a destination node over the network. For example, FIG. 2B, shows an example in-line configuration of network visibility node 220 (e.g. similar to described with respect to FIG. 2A) illustrating an example route of a packet transmitted over a network (e.g. network 110a-b) from a source node 204a (e.g. a host computing device) to a destination node 204b (e.g. a server computing device). Along the example route, a packet may pass through (i.e. be routed, forwarded, etc.) multiple other nodes (e.g. switches 136a-b and routers 130a-b). In the example route depicted in FIG. 2B, both the network visibility node 220 and the tool 250 are deployed in-line with the packet route (i.e. within the flow of network traffic). For example, the packet originates at source node 204a and is destined for destination node 204d. In the example of FIG. 2B, the packet is taped at or at some point after router 230a and received at network port 222 of the network visibility node.

The term “tapping” in this context may generally refer to the routing of copying of packets intended for a destination node 204b from network 110a-b to network visibility node 220. In an out of band configuration this may include copying the packet along its transmission route and transmitting the copied packet to network visibility node 220 without otherwise impacting the “original” packet's route over network 110a-b. In in-line configuration (as illustrated) this may include re-directing the packet to network visibility node 220 before returning the packet to the network 110a-b for transmission to a the designated destination node 204b. In either case, the means for tapping the network traffic can include for example, a physical or virtual tap device (e.g. similar to tap 133 illustrated in FIG. 1B) configured to copy and/or redirect packet traffic. In some cases, a node (e.g. switch 236a or router 230a may include port minoring capabilities. For example any of nodes 236a-b, or routers 230a-b may include a SPAN (switch port analyzer) port configured to copy packets seen on a particular port (or an entire VLAN) via a SPAN port, where the packet can be analyzed.

After reception at network port 222, the packet may be processed at processing unit 242 (e.g. in conjunction with network enumeration module 260) and/or forwarded to an external tool 250 via an instrument port 282. If the packet is forwarded to the instrument port 282 (e.g. according to a user-configurable transmission scheme implemented by the switching fabric of integrated circuit 240), the packet continues to tool 250 for processing. After processing the packet returns to the network visibility node (e.g. via instrument port 282 or another instrument port) where it is then forwarded to network port 224 (e.g. according to a user-configurable transmission scheme implemented by the switching fabric of integrated circuit 240) where it is then transmitted to the destination node 204b (e.g. via nodes 230b and 236b). If after receipt at network port 222 and processing at unit 242, the packet is not forwarded to an external tool, the packet is directly forwarded to network port 224 (e.g. according to a user-configurable transmission scheme implemented by the switching fabric of integrated circuit 240) where it is then transmitted to the destination node 204b (e.g. via nodes 230b and 236b).

### Example Network Enumeration Module

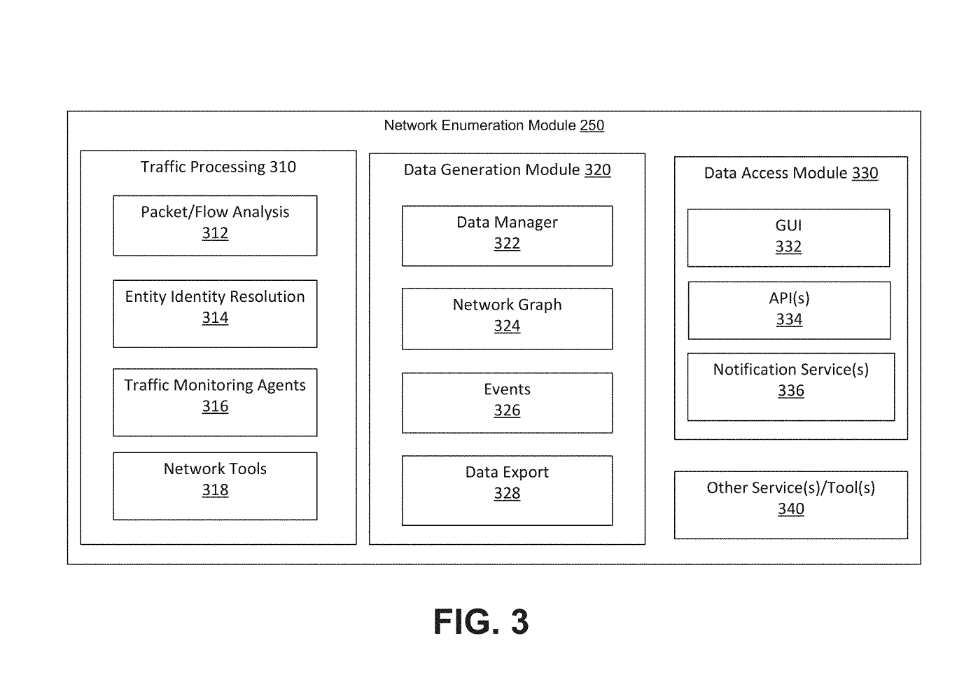

FIG. 3 is a box diagram of an example network enumeration module 260, according to some embodiments. The example network enumeration module 260 illustrated in FIG. 3 may be implemented in any combination of hardware, software, firmware, etc. Further, the example network enumeration module 260 may be implemented at a network visibility node 220 as illustrated in FIGS. 2A-2B, but may in some embodiments be implemented outside of the network visibility node 220 at one or more other devices (real or virtual) that are communicatively coupled to the visibility fabric 180 of FIG. 1B. For example, in some embodiments, network enumeration module 260 (or at least portions thereof) may be implemented at an external tool 250, 252 communicatively coupled to a network visibility node 220. In sonic embodiments network enumeration module 260 (or at least portions thereof) may be implemented at a remote cloud computing service.

As shown in FIG. 3 the example network enumeration module 260 may include one or more submodules, for example for traffic processing 310, data generation 320, data access 330 and for other services 340. Similarly, these sub-modules may in turn include additional submodules that are described in more detail below.

In an embodiment, the traffic processing module 310 is configured to process networks packets for performing the network enumeration processes described herein. For example, the processing unit 242 of network visibility node 220 may receive packets tapped from a network 110a-b and in conjunction with the traffic monitoring module 310, process the packets to identify entities (e.g. computing devices, users, accounts, applications, etc.) connected to the network 110. In some embodiments, the identification of entities can include determining roles and/or capabilities associated with the identified entities. In some embodiments the identification of entities can include determining relationships between entities. To this end, the traffic processing module 310 may include one or more sub modules including, but not limited to a packet/flow analysis module 312, an identity resolution module 314, one or more traffic monitoring agents 316, and other network tools 318.

In an embodiment, the data generation module 320 is configured to generate network enumeration data based on the processing of network traffic by the traffic processing module 310. As used herein, the term “network enumeration data” can refer to any data based on the processing of network traffic for the purpose of identifying entities associated with a particular network and in some cases how those identified entities are related to each other. For example, network enumeration data may include textual listings of entities, data object representations of identified entities, network graphs, graphical outputs, logs, notifications, events, etc.). To this end, the data generation module 320 may include one or more sub modules including, but not limited to, a storage management module 322, a network graph module 324, an events module 326, and a data export module 328.

In an embodiment, the data access module 330 is configured to enable access to the network enumeration data generated by the data generation module 320, for example as a service. To this end, the data access module 330 may include one or more sub modules including, but not limited to, a GUI 332, one or more APIs 334, and one or more notification services 336.

As shown in FIG. 3, in some embodiments network enumeration module 260 may include or integrate with one or more other services/tools 340 (e.g. third-party services. For example in some embodiments network enumeration module 260 may include or integrate with one or more network performance monitoring tools (e.g. Splunk™), security and vulnerability assessment tools (e.g. Blue Coat™), network forensic tools (e.g. Savvius™) etc. In some embodiments the network enumeration module 260 may include or integrate with these other services/tools 340 both to providing network enumeration data and to have services performed for the processing of network traffic and generation of network enumeration data.

It will be appreciated that the network enumeration module 260 illustrated in FIG. 3 is an example embodiment and is provided for illustrative purposes. Other embodiments may include more or fewer sub-modules or may combine or separate sub-modules differently than as shown in FIG. 3.

### Example Processes for Network Enumeration

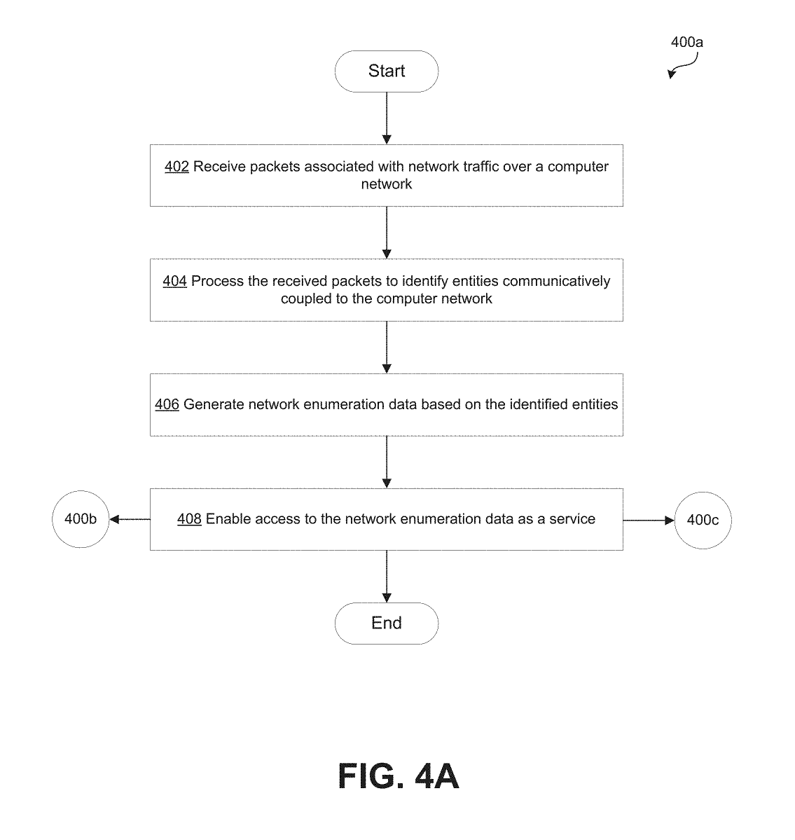

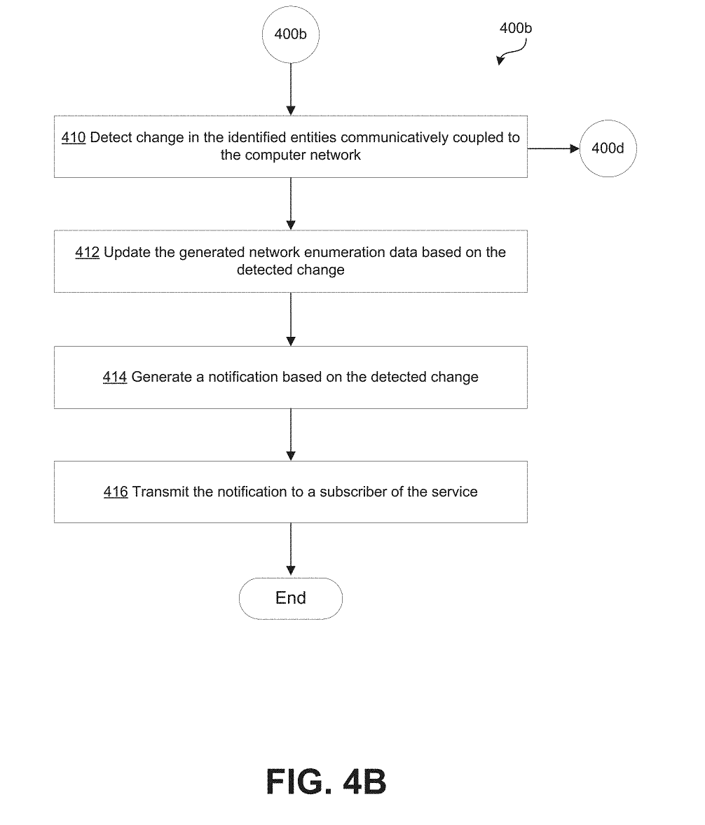

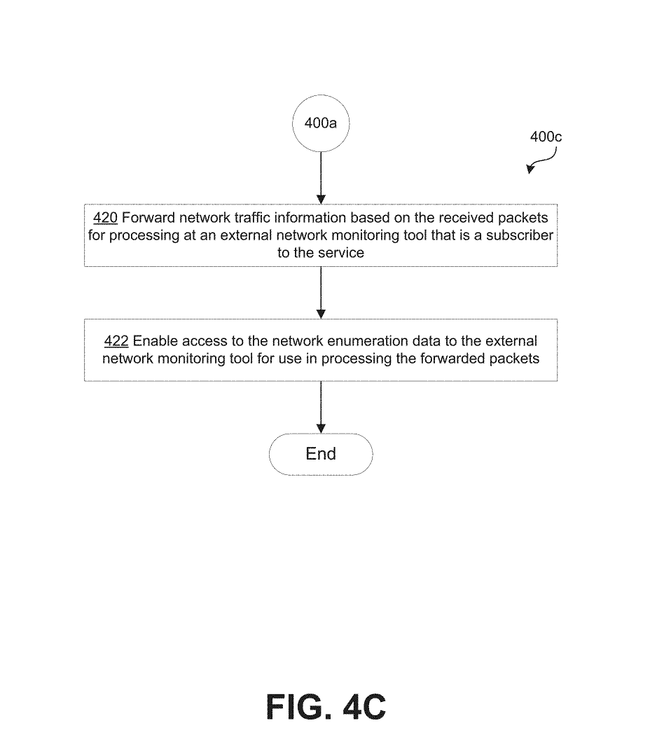

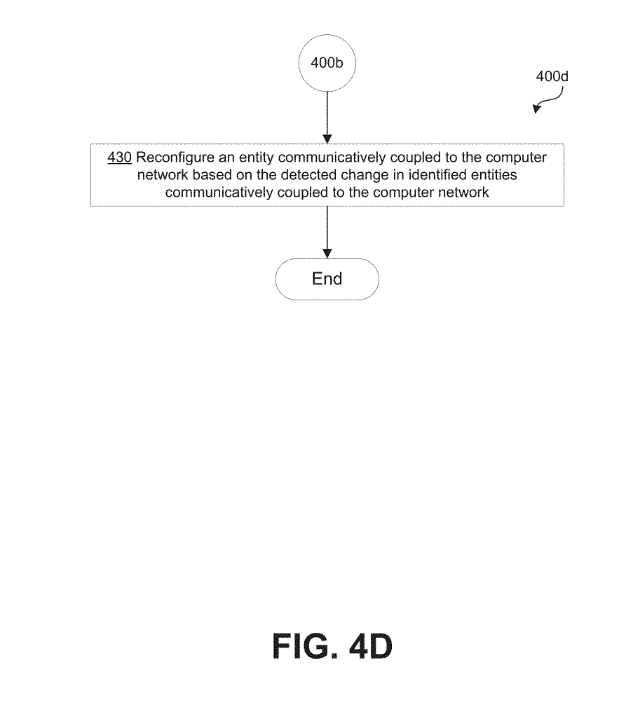

FIGS. 4A-4D show flow diagrams that illustrate example network enumeration processes according to some embodiments. For clarity and illustrative purposes, the processes shown in FIGS. 4A-4D are described with reference to the network enumeration module 260 of FIG. 3, specifically as implemented at the network visibility node 220 of FIGS. 2A-2B. However, in other embodiments, these processes may be performed by other types of devices (e.g. tools 250, 252), and/or other devices having different configurations than as those described with reference to FIGS. 2A-3.

FIG. 4A shows a flow diagram that illustrates a first example process 400a associated with network enumeration. As shown in FIG. 4A, process 400a begins at step 402 with receiving packets associated with network traffic over a computer network. For example, as described with respect to FIGS. 1B and 2A-2B, step 402 may include receiving packets tapped from a computer network (e.g. network 110a-b) via one or more network ports (e.g. ports 222, 224) of a network visibility node 220 operating as part of a visibility fabric 180. As used in this specification, the term “tap” or similar terms, such as “tapped”, may refer to the act of receiving packet or a copy of a packet from a network, wherein such act may be performed by any device (which may or may not be considered a “tap”). In some cases, the act of receiving the packets may be performed by any of the network ports 222, 224, integrated circuit 240, processing unit 242, or network enumeration module 260. In the example configuration depicted in FIG. 2B, the network visibility node 220 may receive packets (or copies of packets) destined for destination node 204b, from nodes any of nodes 204a, 236a, or 230a, In other cases, the act of receiving the packets may be performed by another processing unit at the network visibility node 220. Also, in some cases, the act of receiving the first packet may be performed by a network port (e.g., network port 222) at the network visibility node 220. After the first packet is received by the a network port, the network port then passes the packet downstream to another component (e.g. network enumeration module 260) in the network visibility node 220 for processing.

The process continues at step 404 with processing the received packets to identify entities communicatively coupled to the computer network. This step may be performed by the traffic processing module 310 using any combination of one or more sub modules/processes described below.

In an embodiment packet/flow analysis module 312 may inspect one or more of the received packets to pull information included in the packets that is indicative of entities connected to the network. Received packets will generally include headers that include information regarding the packet and a body of the packet. In an embodiment, the packet/flow analysis module 312 may access multiple layers of packet headers (e.g. transport, network, link, access, etc.) for information. For example, an IP header of an IP packet will generally include a source and destination IP address (e.g., Source IP 1.1.1.1) and an IP protocol identifier. A TCP header of the same packet that is transported using TCP will generally include a TCP source and destination port (e.g., TCP Destination port 60). In addition to inspecting the packets headers, the packet/flow analysis module 312 may also inspect the payload data associated with packets and/or metadata tags that may further indicative of an entity associated with the transmission and/or receipt of the packet. In other words, the packet/flow analysis module may perform deep packet inspection on the received packets.

In an embodiment the packet/flow analysis module 312 may be configured to process a series of packet belonging to a network flow. A network flow generally refers to a series of packets from a source node to a destination node, for example related as part of a specific connection, communication exchange, stream of information, etc. The processing of network flows may include sampling some or all of the received packets that match a certain criteria associated with a given network flow. For example, as previously mentioned, the packet/flow analysis module 312 may examine attributes in the packet headers of received packets (e.g. IP protocol, source IP address, destination IP address, source port, destination port, etc.) to determine that the certain packets are associated with a select network traffic flow.

In either case, inspection of the received packets by the packet/flow analysis module 312 can be performed to determine any number of characteristics regarding entities connected to a computer network. For example, packet/flow analysis module 312 may determine what hosts are available on the network, what services (application name and version) those hosts are offering, what protocols the hosts are communicating over, what operating systems (and OS versions) they are running, what type of packet filtering rules/firewalls are in use, etc.

In an embodiment, step 404 may include an entity identity resolution process performed by an entity identity resolution module 314. As previously discussed, the term an entity can refer to any of device, a user, and application, etc. associated with a computer network. Certain entities may be associated with each other. For example, through processing the received packets (e.g. by packet/flow analysis module 312) the network enumeration module 260 may determine identifiers associated with certain devices (e.g. UUID, MAC address, etc., phone number), users (UID, email address), applications, etc. communicating over the network. In some cases, particularly in a network management and security context, it may be useful to know if some of these entity identifiers are related to each other. For example, a particular user may communicate via a particular application executing at a particular computing device. In some embodiments an identify resolution process can be applied module 314 to monitor the behavior of certain identified entities over a period of time to associate those entities with other entities. For example, by applying such a process module 314 may determine that multiple IP addresses are associated with traffic by a particular user. This may indicate that the multiple IP addresses are associated with different devices used by the particular user and/or that a single device used by the user has been associated with a dynamic IP address.

In some embodiments step 404 may include identifying an processing packets that are part of certain traffic over the network. For example, as previously mentioned, traffic processing module 310 may include one or more network monitoring agents/managers 316 configured to identify and interpret network management protocol (e.g. SNMP) messages transmitted over the network, for example between managed devices. In an embodiment the a network monitoring agent/manger 316 may actively send and receive management messages, for example to query connected devices for configuration information. In some embodiments, the or more network monitoring agents/managers 316 may listen for management messages transmitted over the network for example between other network monitoring agents and managers.

In some embodiments step 404 may include processing of received packets by existing network tools to identify entities on the network. For example, network tools module 318 is illustrated as a sub-module of traffic processing module 310 in FIG. 3. In other embodiments, such processes may be applied by tools external to a network visibility node (e.g. tools 250, 252). In either case, any number of existing network monitoring/security tools may be applied to assist in identifying entities associated with a given network, including, but not limited to, Nmap™, Enum™, Nessus™, etc.

The process continues at step 406 with generating network enumeration data based on the identified plurality of entities communicatively coupled to the computer network. This step may be performed by the data generation module 330 using any combination of one or more sub modules/processes described below.

As previously mentioned, “network enumeration data” can refer to any data based on the processing of network for the purpose of identifying entities communicatively coupled to a particular network. For example, network enumeration data may include entity identifiers such as addresses (e.g. IP address, MAC address, email address, phone number), unique identifier (e.g. user IDs, hardware serial numbers, etc.), port designations, etc. The network enumeration data may also include other information associated with the identified entities such as their role (e.g. classification such as “switch,” “web server,” “printer,” etc.), available services, capabilities, usage statistics (e.g. avg. bytes uploaded/downloaded over a time period), etc.). The data may be generated in any format suited to a particular implementation. For example, network enumeration data may be generated as textual data, spreadsheets, data objects, structured data, events, logs, graphical outputs, etc. For example, step 406 may include generating lists of identified entities (including identifiers and other attributes) based on the processing performed at step 404. In some cases, this may include assigning new unique identifiers to identified entities. As another example, step 406 may include generating data objects (e.g. in JSON format) representative of identified entities. In some cases these generated objects may be structurally organized, for example like a management information base (MIB). In some embodiments step 406 may include generating values based on the identified entities for entry into various data structures (e.g. a database). The data manager 322 may provide certain functionalities associated with the generation, storage, and maintenance of generated network enumeration data.

In some embodiments, network enumeration data may be organized into or represented as a network graph. For example a network graph module 324 may enable the organization of generated data objects representative of identified entities into a network graph that includes a plurality of nodes associated with the entities and edges connecting certain entities based on identified relationships. For example a given network may be represented as a graph of devices represented by nodes communicatively coupled to each other as represented by edges connecting certain nodes. The network graph module 324 may maintains a graph of entities on the network and provide a set of services updating the graph based on detected changes in the identified entities. For example, in some embodiments the network graph module 324 may maintain the graph as a data object. The graph object maintains the relationships between nodes and edges in the graph and allows for the addition, removal, replacement, of nodes as necessary based on detected changes in the identified entities. As will be explained, in some embodiments, the graph object may raise an event to notify others of a modification of the graph object. For example, in some embodiments the network enumeration data may include events generated by an events module 326 in response to detected changes in the identified entities connected to the computer network.

In some embodiments data generation module 320 may be configured to generate a visual representation (e.g. a graphical map) of the identified entities. For example, the graphical map may include a graphical icon representing one or more of the identified entities, and another graphic to represent connections between the devices. The graphical map may, for example, use one type of icon to indicate a wired connection, and another type of icon to indicate a wireless connection. The map may also show other information associated with the entities such as their role (e.g. a displayed classification such as “switch,” “web server,” “printer,” etc.), available services, capabilities, usage statistics, etc.

In some embodiments, step 406 may include transforming by a data export module 328 at least some of the stored network enumeration data into a new format for export, for example in response to a request by a subscriber to the service. For example, in an embodiment the network enumeration data may be stored an managed as a network graph as described above. A subscriber to the service may request at least a portion of the network enumeration data in a particular format (e.g. as a JSON object), in response, the data export module 328 may access the requested data, transform the data into the requested format, and export the transformed data to the requester.

In any of the above described embodiments the generated network enumeration data may be stored, for example, locally at the network visibility node 220 and/or at one or more remote data storage systems communicatively coupled to the network visibility node.

The example process 400a continues at step 408 with enabling access to the generated network enumeration data as a service. This step may be performed by the data access module 330 using any combination of one or more sub modules/processes described below.

As alluded to in previous paragraphs, in an embodiment the generated network enumeration data is made accessible (i.e. published) for others as a service. For example, in an embodiment, users (e.g. network administrators, security officers) and other network monitoring/management/security tools, services, devices, etc. may subscribe to a network enumeration service to access the network enumeration data generated at step 406. Access may be provided via one or more application program interfaces (APIs) 334). These various accessing entities are generally referred to herein as “subscribers.” As previously mentioned, the generated network enumeration data may reside at a network visibility node 220 or at any number of remote storage systems. Similarly, access to the network enumeration data may be provided via communications link with the network visibility node (e.g. direct or indirect over the Internet) or may be provided via a remote computing platform.

In some embodiments, user subscribers may access the network enumeration via a graphical user interface (GUI) displayed at a user device (e.g. a computer or mobile device). In such embodiments, a GUI module 332 instantiated at the network visibility node, user device, and/or another remote computing device may cause display of the an interactive GUI through which the user may access the network enumeration data. In some embodiments the GUI may be implemented, for example, via an application or web browser interface. Such users may access the network enumeration data in order to, for example, manage the network, detect security threats, update policies and rules, etc.

As mentioned, subscribers may not always be human users. Some subscribers to the service may be devices operating on the network, other management/monitoring/security systems and tools, etc. For example, accurate network enumeration data is highly valuable to any tool performing network monitoring and security functions. In some cases such tools may perform some network enumeration processes themselves, however by offloading this processing and accessing accurate data through a separate service, the tools can focus on their primary tasks (e.g. detecting security threats).

FIG. 4B shows a flow diagram that illustrates a second example process 400b associated with network enumeration. The process 400b may continue from the process 400a described with respect to FIG. 4A. In an embodiment process 400b begins at step 410 with detecting a change in the identified entities communicatively coupled to the computer network. In this context, a detected change may include a change in configuration/capabilities/attributes of a previously identified entity, a removal of a previously identified entity from the computer network, and/or the addition of a newly identified entity to the computer network. In response to detecting the change, the process continues at step 412 with updating the network enumeration data based on the detected change. For example, as previously mentioned, the network graph module 324 may update the graph object based on the detected change.

In some embodiments, subscribers to the network enumeration service may subscribe to one or more notification services 336 to receive updates on when changes are detected in the identified entities connected to the network. In such embodiment process 400b may continue at step 414 with generating a notification by the notification service 336 and at step 416 with transmitting the notification to a device associated with the subscriber to the notification service. In some embodiments notifications are generated as events (e.g. in conjunction with the events module 326). In some embodiments notifications are generated as messages (e.g. text messages, email, page, etc.). In some embodiments subscribers can configure their notification service via the module 336. For example, a subscriber may configure the notification service to transmit notifications only for certain detected changes (e.g when new entities are detected, when changes are detected to certain categories of entities (e.g. server devices)).

FIG. 4C shows a flow diagram that illustrates a third example process 400c associated with network enumeration. The process 400c may continue from the process 400a described with respect to FIG. 4A. In an embodiment process 400c begins at step 420 with forwarding network traffic information based on the received packets for processing at an external network tool that is a subscriber to the service and continues at step 422 with enabling access to enumeration data to the external network tool for use in processing the forwarded packets. Note that in the network traffic information can include the received packets and/or metadata extracted from the received packets. Consider again the example embodiment of a network visibility node 222 communicatively coupled to an external tool 250 depicted in FIG. 2B. As previously mentioned, the example embodiment depicted in that figure is of an in-line network visibility node 220 as well as an in-line tool 250. In other words, a packet originating at node 204a and destined for node 204b passes through tool 250 for processing by way of forwarding by network visibility node 220. The tool may be configured for any type of packet processing which may in some cases benefit form accurate knowledge of the entities connected to the computer network over which the packet is transmitted. Accordingly, the tool 250 may subscribe to a network enumeration service (e.g. provided based on processing by a network enumeration module 260) in order to access accurate network enumeration data. In other words as packets are receive at network visibility node 220 (e.g. via network port 222) they may be processed (e.g. according to process 400a) for the purpose of extracting metadata and/or generating enumeration data and/or may be forwarded to tool 250 (e.g. via instrument port 282) for processing. Tool 250 may be a subscriber to the network enumeration service provided at least in part by the network visibility node 220 and may access the network enumeration data via the service to assist in its own processing.

FIG. 4D shows a flow diagram that illustrates a fourth example process 400d associated with network enumeration. The process 400d may continue from the process 400b described with respect to FIG. 4B. As shown in FIG. 4D, process 400d may include a step 430 that involves configuring or reconfiguring an entity communicatively coupled to the computer network based on the detected change in the identified entities communicatively couple to the network (e.g. based on processes 400a and 400b). Reconfiguration may include changing certain attributes, settings, policies, rules, etc. at a particular entity (i.e. a device or application) or may in some cases include, for example, installing software (e.g. for network security/management). As an illustrative example, a network enumeration service may be configured to cause the automatic download and implementation of certain network management/security software to a newly detected device connecting to a computer network. As another illustrative example, a network enumeration service may be configured to cause the application of new or modified network traffic rules at certain devices. For example, consider a router or switch on the network applying a rule to direct web traffic to or from a set of web servers via a particular firewall. The addition of a new web server to the network may, based on the enumeration and notification techniques described herein, and without any input from a network administrator, automatically trigger a new rule or the modification of the existing rule at the router or switch such that traffic to and from the new web server is routed via the firewall as well. These are only a couple of illustrative examples of how a network enumeration service may assist in the effective management of a network.

### Example Deployment in a Network Environment

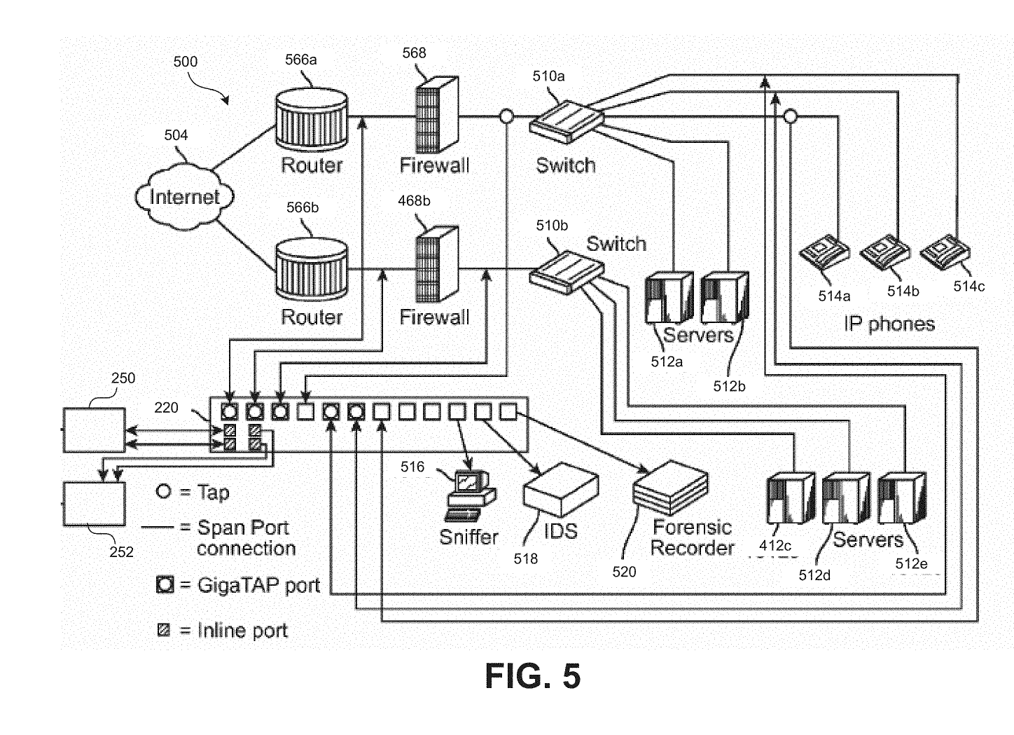

FIG. 5 shows the deployment of a network visibility node (e.g. network visibility node 220) in a network environment 500 in accordance with some embodiments. The Internet 504 is coupled via routers 566a-b and firewalls 568a-b to two switches 510a and 510b. Switch 510a is coupled to servers 512a-b and IP phones 514a-c. Switch 510b is coupled to servers 512c-e. A sniffer 516, an IDS 518 and a forensic recorder 520 (collectively, “non-pass through instruments”) are coupled to the network visibility node 220. As illustrated in FIG. 5, there is a reduction on the number of non-pass through instruments in this deployment as compared to a conventional configuration (in which there may be one or more non-pass through instruments between router 566a and firewall 568a, one or more non-pass through instruments between firewall 568a and switch 510a, one or more non-pass through instruments between router 566b and firewall 568b, and firewall 568b and switch 510b) because the same non-pass through instruments can now access information anywhere in the network environment 500 through the appliance 220. The user has complete flexibility to channel whatever traffic to whatever instrument or groups of non-pass through instruments, using the any-to-any, any-to-many and many-to-one capability of the system in accordance with the different embodiments described herein. For example, all the conversations of the IP phones 514a-c can be easily configured to be sent to an IDS 518. It is also possible that traffic inside a particular IP phone 514a-c connection can be sent to a sniffer 516, and Intrusion Detection System 518 and a forensic recorder 520 simultaneously via the one-to-many function.

In some embodiments, when using the appliance 220, one or more non-pass through instruments (such as IDS, sniffer, forensic recorder, etc.) may be connected to instrument port(s), and one or more pass through tools 250, 252 (e.g., IPS) may be connected to other instrument port(s) (e.g., in-line port(s)). Such configuration allows non-pass through instrument(s) and pass through instrument(s) to simultaneously monitor the network traffic. Each non-pass through instrument is in listening mode (i.e., it receives packets intended to be communicated between two nodes), and each pass through instrument is in pass-thru mode (i.e., it receives packets intended to be communicated between two nodes, processes them, and then pass the packets downstream towards the intended recipient node). In some cases, by having both an IDS and an IPS connected to the appliance 220, the appliance 220 can compare whether the IDS or the IPS sees more threats, and/or can have a redundant protection such that if the IPS misses any threat, the IDS may pick it up.

### Example Processing System

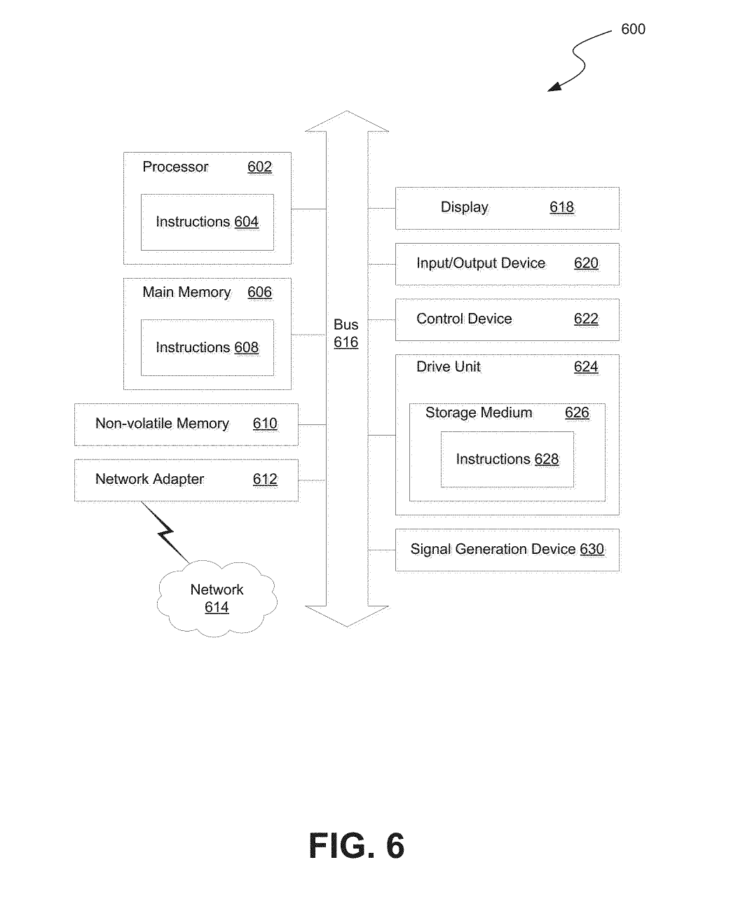

FIG. 6 is a block diagram illustrating an example of a processing system 600 in which at least some operations described herein can be implemented. For example, at least a portion of the processing system 600 may be included in a network appliance (in that case, the processing system 600 may not include a display 618, but could instead include a switching fabric and one or more network ports). The computing system may include one or more central processing units (“processors”) 602, main memory 606, non-volatile memory 610, network adapter 612 (e.g., network interfaces), display 618, input/output devices 620, control device 622 (e.g., keyboard and pointing devices), drive unit 624 including a storage medium 626, and signal generation device 630 that are communicatively connected to a bus 616. The bus 616 is illustrated as an abstraction that represents any one or more separate physical buses, point to point connections, or both connected by appropriate bridges, adapters, or controllers. The bus 616, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.” A bus may also be responsible for relaying data packets (e.g., via full or half duplex wires) between components of the network appliance, such as the switching fabric, network port(s), tool port(s), etc.

In various embodiments, the processing system 600 operates as a standalone device, although the processing system 600 may be connected (e.g., wired or wirelessly) to other machines. For example, the processing system 600 may include a terminal that is coupled directly to a network appliance. As another example, the computing system 600 may be wirelessly coupled to the network appliance.

In various embodiments, the processing system 600 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 606, non-volatile memory 610, and storage medium 626 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 628. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module, or sequence of instructions referred to as “computer programs.” The computer programs typically comprise one or more instructions (e.g., instructions 604, 608, 628) set at various times in various memory and storage devices in a computer, and that, when read and executed by one or more processing units or processors 602, cause the processing system 600 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include recordable type media such as volatile and non-volatile memory devices 610, floppy and other removable disks, hard disk drives, optical disks (e.g., Compact Disk Read-Only Memory (CD ROMS), Digital Versatile Disks (DVDs)), and transmission type media such as digital and analog communication links.

The network adapter 612 enables processing system 600 to mediate data in a network 614 with an entity that is external to the processing system 600, such as a network appliance, through any known and/or convenient communications protocol supported by the processing system 600 and the external entity. The network adapter 612 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 612 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, including intrusion prevention, intrusion detection, next-generation firewall, personal firewall, etc.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

Note that any of the embodiments described above can be combined with another embodiment, except to the extent that it may be stated otherwise above or to the extent that any such embodiments might be mutually exclusive in function and/or structure.

Although the present innovation has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
receiving, at network visibility node communicatively coupled to a computer network, a plurality of packets associated with network traffic on the computer network, the network traffic sent and/or received by a plurality of entities associated with the computer network;
processing, by the network visibility node, the received packets to identify the plurality of entities associated with the computer network based on data included in the received packets;
generating and storing, by the network visibility node, network enumeration data indicative of the identified plurality of entities associated with the computer network; and
enabling access, by the network visibility node, to the network enumeration data as a service to subscribers of the service.

2. The method of claim 1, wherein the network visibility node operates out-of-band with the computer network.

3. The method of claim 1, wherein the plurality of entities include any one or more of a device, a user, or an application.

4. The method of claim 1, wherein the subscribers of the service include any one or more of a device, a user, an application, or another service.

5. The method of claim 1, wherein the network visibility node is communicatively coupled to the computer network via a network tap or a packet mirroring port.

6. The method of claim 1, wherein the network visibility node is part of a visibility fabric, wherein the visibility fabric is communicatively coupled to at least one network tool, and wherein the visibility fabric is operable to enable visibility across the computer network by routing network traffic information to the at least one network tool, the network traffic information including any of:
at least some of the received plurality of packets; or
metadata extracted from at least some of the received plurality of packets.

7. The method of claim 1, further comprising:
detecting a change in the identified plurality of entities communicatively coupled to the computer network.

8. The method of claim 7, wherein the detected change includes any of:
a change in configuration of a previously identified entity;
removal of a previously identified entity from the computer network; or
addition of a newly identified entity to the computer network.

9. The method of claim 7, further comprising:
generating a notification in response to detecting a change in the identified plurality of entities; and
transmitting the notification to a subscriber of the service.

10. The method of claim 7, further comprising:
updating the network enumeration data based on the detected change in response to detecting the change in the identified plurality of entities.

11. The method of claim 7, further comprising:
causing application of a network traffic rule in the computer network in response to the detected change in the identified plurality of entities.

12. The method of claim 1, wherein the service is accessible via an application program interface (API).

13. The method of claim 1, wherein enabling access to the network enumeration data includes publishing the enumeration data for access by the subscribers of the service.

14. The method of claim 1, wherein the network enumeration data is accessible to the subscriber via the service as any one or more of:
a spreadsheet;
a data object;
an event; or
a log.

15. The method of claim 1, wherein the network enumeration data includes a listing of entity identifiers associated with the identified plurality of entities.

16. The method of claim 1, wherein the network enumeration data includes a visual representation of relationships between at least some of the identified plurality of entities.

17. The method of claim 1, wherein processing the plurality of packets to identify the plurality of entities includes determining an entity type or entity role for at least one of the identified plurality of entities.

18. The method of claim 1, wherein processing the plurality of packet to identify the plurality of entities includes determining relationships between two or more of the identified plurality of entities.

19. The method of claim 1, wherein a particular entity of the plurality of entities is identify based on an analysis of any of a packet identifier, a source identifier, a destination identifier, a protocol identifier, or other metadata included in the received packets.

20. The method of claim 1, further comprising:
forwarding network traffic information to a network tool communicatively coupled to the network visibility node for processing, the network traffic information including any of:
at least some of the received plurality of packets; or
metadata extracted from at least some of the received plurality of packets;
wherein the network monitoring tool is the subscriber of the service and is operable to access the network enumeration data via the service for use in the processing of the network traffic information.

21. A system comprising:
a processing unit;
a network port configured to communicatively couple the processing unit to a computer network; and
a memory unit having instructions stored thereon, that when executed by the processing unit cause the system to:
receive, via the network port, a plurality of packets associated with network traffic over the computer network;
process the received packets to identify a plurality of entities communicatively coupled to the computer network based on data included in the received packets;
generate network enumeration data based on the identified plurality of entities communicatively coupled to the computer network; and
enable access to the network enumeration data as a service.

22. A network visibility node comprising:
a network port through which to communicate with a computer network;
an instrument port through which to communicate with an external network monitoring tool; and
a processing unit communicatively coupled to the network port, the processing unit configured to:
receive, via the network port, a plurality of packets associated with network traffic over the computer network;
process the received packets to identify a plurality of entities communicatively coupled to the computer network based on data included in the received packets;
generate network enumeration data based on the identified plurality of entities communicatively coupled to the computer network; and
enable access to the network enumeration data as a service.
